(19) United States
(12) Patent Application Publication
(10) Pub. No.: US 2009/0156758 A1
(43) Pub. Date: Jun. 18, 2009

(54) Gas-Phase Process for the Poymerization of Olefins

(75) Inventors: Joachim Pater T.M., Ferrara (IT); Pietro Baita, Rovigo (IT); Gabriele Mei, Ferrara (IT); Antonio Mazzucco, Ferrara (IT)

Correspondence Address: Basell USA Inc., Delaware Corporate Center II, 2 Righter Parkway, Suite #300, Wilmington, DE, 19803, US

(73) Assignee: BASELL POLIOLEFINE ITALIA S.R.L., Milan (IT)

(21) Appl. No.: 11/992,032

(22) PCT Filed: Sep. 15, 2006
(86) PCT No.: PCT/EP2006/066421

§ 371 Date: Mar. 14, 2008

Related U.S. Application Data
(60) Provisional application No. 60/720,025, filed on Sep. 23, 2005.

(30) Foreign Application Priority Data
Sep. 19, 2005 (EP) 05108618.9

(51) Int. Cl. C08F 2/01; B01J 19/24

(52) U.S. Cl. 526/64; 422/132

(57) ABSTRACT

A process for the gas-phase polymerization of one or more alpha-olefins in the presence of a polymerization catalyst system, the process comprising: a) contacting in a continuous way a gas comprising one or more of said alpha-olefins with said catalyst system in a gas-phase tubular reactor at a temperature from 30° C. to 130° C. in order to obtain a polymerization degree up to 500 grams per gram of catalyst system; b) feeding in continuous the prepolymer from step a) to a successive gas-phase polymerization reactor; wherein said gas-phase tubular reactor has a length/diameter ratio higher than 100.

The present invention relates to a process and apparatus for the gas-phase polymerization of α-olefins carried out in the presence of a polymerization catalyst system. In particular, the invention relates to polymerization of α-olefins, wherein the catalyst system is subjected to a prepolymerization step in a gas-phase before the successive feeding to one or more gas-phase polymerization reactors.

The development of olefin polymerization catalysts with high activity and selectivity, particularly of the Ziegler-Natta type and, more recently, of the metallocene type, has led to the widespread use on an industrial scale of processes in which the polymerization of olefins is carried out in a gaseous medium in the presence of a solid catalyst.

A widely used technology for gas-phase polymerization processes is the fluidized bed technology as well as the stirred bed technology. When the gas-phase polymerization of one or more olefins is carried out in a fluidized or mechanically stirred bed reactor, the polymer is obtained in the form of granules having a more or less regular morphology, depending on the morphology of the catalyst: the dimensions of the granules are generally distributed around an average value and they depend on the dimensions of the catalyst particles and on the reaction conditions.

In the conventional stirred or fluidized gas-phase reactors the heat of polymerization is removed by means of a heat exchanger placed inside the reactor or in the recycle line of the unreacted monomers. The reacting polymer bed consists of polymer particles with a defined geometrical shape and a granulometric distribution preferably narrow, generally distributed over average values higher than 500 μm. However, a detrimental problem commonly to be faced in these polymerization processes is given by the presence of a significant amount of fine polymer particles. Fine particles of polymer (fines) can be produced by the breakage of the catalyst or derived from already existing fine catalyst particles. Said fine particles tend to deposit onto and to electrostatically adhere to the pipes of the heat exchanger, as well as to deposit onto and electrostatically adhere to the inner walls of the polymerization reactor. Thereafter, the fines grow in size by polymerization inside the heat exchanger, thus causing an insulating effect and a lower heat transfer resulting in the formation of hot spots in the reactor.

These negative effects are even enhanced when the gas-phase olefin polymerization is carried out in the presence of highly active catalyst systems, such as those comprising the reaction product of an aluminum alkyl compound with a titanium compound supported on a magnesium halide.

As a consequence, a loss in the efficiency and homogeneity of the fluidization conditions of the polymer bed generally occurs. For example, the clogging of the polymer discharge system may occur. Moreover, the temperature excess caused by hot spots in the reactor can result in particles melting with the consequent formation of polymer lumps, which may clog the gas distribution plate placed at the bottom of the fluidized polymer bed. All these drawbacks lead to a poor process stability and can lead to a forced interruption of the polymerization run in order to remove the deposits which have formed inside the reactor or into the gas recycle line even after relatively short times.

It is known that the pre-polymerization of the catalyst system can help to improve the morphological stability of the solid particles of catalyst, reducing the probability of breakage of portions of them. Such a prepolymerization of the catalyst particles is commonly performed in a liquid phase by means of a loop reactor or a stirred tank reactor. However, when the polymerization is aimed to the production of ethylene polymers, especially in the case of bimodal polyethylene, a particularly high morphological stability of the catalyst particles is required.

Bimodal polyethylene is usually prepared in a sequence of two serially connected polymerization reactors, the first reactor producing ethylene homopolymer having a high melt index (MI), the second reactor producing a low MI polyethylene modified with a comonomer, usually 1-butene or 1-hexene. The high Ml homopolymer prepared in the first reactor is a crystalline polymer which is particularly brittle, so that its tendency to breakage can be contrasted by a higher morphological stability of the catalyst particles, thus improving the reliability and reproducibility of the polymerization process.

According to the prior art on the gas-phase processes for preparing ethylene polymers the prepolymerization of the catalyst components is generally performed in a liquid phase by dissolving small amounts of ethylene monomer in a liquid hydrocarbon solvent, propane being generally the most preferred solvent.

As an example of the above technique, the disclosure of EP 560312 in Examples 1-2 describes the preparation of HDPE and LLDPE by means of two fluidized-bed reactors connected in series. After the activation step of the Ziegler-Natta catalyst components, a slurry prepolymerization step with ethylene in a loop reactor is performed using propane as the liquid medium. However, it has been frequently observed that pre-polymerizing a Ziegler-Natta catalyst system by means of ethylene in liquid propane gives rise to fouling problems inside the prepolymerization reactor and in the line connecting the prepolymerizator to the main polymerization reactor.

The above drawback can be solved by the use of liquid propylene instead of ethylene when prepolymerizing the catalytic components before the successive gas-phase polymerization of ethylene in one or more gas-phase reactors. As an example of this technique, the disclosure of EP 541760 in Examples 1-2 describes the preparation of LLDPE and HDPE by means of two fluidized-bed reactors connected in series: the prepolymerization of the catalyst particles is performed in a liquid loop reactor, to which liquid propylene and propane are fed. As a negative consequence of this method, small amounts of unreacted propylene can enter the first gas phase reactor, thus causing a contamination of the crystalline ethylene polymer prepared in the first reactor and a consequent loss of quality of the final polyethylene composition.

EP 279153 relates to polymerization of propylene in a liquid phase. Upstream the liquid-phase polymerization, the carrier fluid containing the catalyst components is supplied to a tubular reactor, where it is mixed with liquid propylene to carry out the prepolymerization of the catalyst components. The residence time within the tubular reactor ranges from about 2 to 10 seconds, while the pre-polymerization temperature is maintained at values of less than 30° C. If applied to the preparation of polyethylene compositions, the liquid-phase prepolymerization described in EP 279153 would give the drawbacks as above mentioned:
in case of prepolymerization by propylene, small amounts of unreacted propylene could enter the first gas-phase reactor, thus causing a contamination of the crystalline ethylene polymer prepared in this reactor;
in case of prepolymerization by ethylene, the fouling problems inside the prepolymerization reactor would be unacceptable.

It would be highly desirable to avoid the drawbacks correlated with the liquid-phase prepolymerization taught by the prior art, finding an alternative process to carry out the prepolymerization of the catalyst components.

U.S. Pat. No. 6,518,372 relates to a process and apparatus for the gas-phase polymerization of α-olefins, wherein the polymerization is carried out in a tubular reactor having a length/diameter ratio higher than 100. The growing polymer particles pass through said tubular reactor in its longitudinal direction without a substantial recycle of the polymer particle stream. The polymerization process disclosed in U.S. Pat. No. 6,518,372 is able to guarantee a narrow residence time distribution to the polymer particles growing in said tubular reactor.

It has now been found that when the catalyst components are pre-polymerized in a gas-phase within a tubular reactor having the configuration described in U.S. Pat. No. 6,518,372, the morphological stability of the catalyst particles is significantly improved. In particular, a reduction of the formation of fine polymer particles in the successive step of gas-phase polymerization is achieved.

It is therefore an object of the present invention providing a process for the gas-phase polymerization of one or more alpha-olefins in the presence of a polymerization catalyst system, the process comprising:
a) contacting in a continuous way a gas comprising one or more of said alpha-olefins with said catalyst system in a gas-phase tubular reactor at a temperature from 30° C. to 130° C. in order to obtain a polymerization degree up to 500 grams per gram of catalyst system;
b) feeding in continuous the prepolymer from step a) to a successive gas-phase polymerization reactor,
   wherein said gas-phase tubular reactor has a length/diameter ratio higher than 100.

The polymerization process of the present invention allows achieving an optimal particle size distribution of the obtained polyolefin powders and this positive result is achieved without having the fouling problems commonly encountered when the catalyst system is prepolymerized by ethylene in a liquid phase.

The particle size of the obtained polymer particles is generally distributed between 0.1 and 5.0 mm, with most of particles having a size in the range from 0.5 to 3.0 mm. Defining as “fines” the polymer particles smaller than 0.3 mm, the total amount of fines formed in the polymerization process of the present invention is generally less than 2.0% by weight.

Especially when applied to ethylene polymerization, the process of the invention is particularly advantageous, since there is no need of using propylene as the pre-polymerizing monomer: ethylene can be advantageously used in the present invention as the prepolymerization monomer without incurring in fouling problems inside the prepolymerizator.

According to the process of the invention, the prepolymerization step a) is carried out in a tubular reactor having a high ratio of length/diameter, this kind of tubular reactor being described in the specification of U.S. Pat. No. 6,518,372. Good flow of prepolymer particles with approximately plug flow and also narrow residence time distributions are obtained in tubular reactors having a length/diameter ratio higher than 100. In the case of extremely long and thin reactors, either the pressure drop in the direction of the longitudinal coordinate is uneconomically high or the throughput achieved is too small, so that the reactor geometry is limited by these considerations. The tubular reactors used in the present invention have a length/diameter preferably in the range from 100 to 2000. A preferred geometry of the prepolymerization reactor according to the invention for the industrial, commercial scale has a tube diameter in the range from 1 to 50 cm, and a length of from 10 to 200 m.

The average residence time in step a) of the invention is the ratio between the polymer hold-up and the polymer discharged from the tubular reactor. The polymer residence time generally ranges from 10 seconds to 15 minutes, preferably from 40 seconds to 10 minutes: this parameter can be modified by increasing or decreasing the gas velocity within the tubular reactor. The gas conveying the prepolymer along the tubular reactor of step a) comprises, besides the olefin monomers to be polymerized, also an inert compound, preferably selected from nitrogen, ethane, propane, butane, pentane and hexane. The gas velocity within the tubular reactor is adjusted at high values to maintain fast fluidization conditions of the prepolymer flowing inside the reactor. As it is known, the state of fast fluidization is obtained when the gas velocity is higher than the transport velocity, so that to ensure the entrainment of the solid throughout the reactor. The terms “transport velocity” and “fast fluidization state” are well known in the art: for a definition thereof, see, for example, “D. Geldart, Gas Fluidisation Technology, page 155 et seq., J. Wiley & Sons Ltd., 1986”. Accordingly, in the process of the invention the gas velocity in step a) is maintained in a range from 15 to 300 cm/s, preferably from 20 to 150 cm/s, so as to avoid the settling of solid particles within the tubular reactor. The choice of a tubular reactor having L/D higher than 100 and characterized by fast fluidization conditions and short polymer residence times is advantageous with respect to tubular reactors operating in a plug flow, but with a lower L/D ratio, for instance of less than 50: the latter are not advantageous from the economical point of view, since they require the use of one or more stirring devices to ensure the transport of the prepolymer along the length of the reactor.

The temperature and pressure conditions in step a) of the present invention can be selected in a broad range. The prepolymerization can be carried out at a temperature from 30° C. to 130° C., preferably from 70 to 120° C., while the pressure can be selected within the ranges which are customary for gas-phase polymerizations, i.e. from 1 to 100 bar, preferably from 5 to 50 bar.

As above indicated, the polymerization degree in step a) is lower than 500 grams per gram of solid catalyst component, preferably lower than 250 grams, most preferably ranging from 0.1 to 100 grams per gram of solid catalyst component.

The prepolymerization step a) is optionally carried out in the presence of a molecular weight regulator, such as hydrogen. Hydrogen can be fed to the prepolymerization reactor with a H₂/olefin molar ratio generally comprised between 0 and 5.0.

As regards the polymerization catalyst system fed to step a), highly active catalyst systems of the Ziegler-Natta or metallocene type can be used.

A Ziegler-Natta catalyst system comprises the catalysts obtained by the reaction of a transition metal compound of Ti, V, Zr, Cr, and Hf with an organometallic compound of group 1, 2, or 13 of the Periodic Table of element.

A metallocene-based catalyst system comprises at least a transition metal compound containing at least one π bond and at least an alumoxane or a compound able to form an alkylmetallocene cation, and optionally also an organo-aluminum compound.

It is known that the prepolymerization of a catalyst system is generally preceded by the preactivation of the solid catalytic component. The latter, a cocatalyst and optionally an electron donor compound are generally pre-contacted within a pre-contacting vessel in a liquid carrier, such as propane or hexane. As a consequence, the evaporation of the above liquid carrier is preferably performed before feeding the activated catalyst components to the gas-phase prepolymerization step a). Therefore, upstream the prepolymerization step a), the pre-contact of the catalyst components in a liquid medium and the successive evaporation of said liquid medium are performed. Said evaporation can be carried out in a heat exchanger using steam as the heating fluid.

The tubular reactor of step a) comprises at least a facility for feeding the reaction gas, at least a facility for feeding the catalyst components, at least a facility for transferring the formed prepolymer to the successive polymerization reactors, and optionally a facility for separating the reaction gas from the prepolymer particles and recirculating said reaction gas to the inlet region of the reactor. Said facility for separating the reaction gas from the prepolymer particles can be installed at the end of the tubular reactor. The separation of the polymer particles from the gas stream is preferably carried out by means of a cyclone.

The growing prepolymer particles pass through the tubular reactor of step a) in its longitudinal direction without a significant part of the prepolymer stream being recirculated. However, small amounts of prepolymer can be entrained in the circulating reaction gas and can be recirculated in this way.

The prepolymerization step a) is preferably carried out in a tubular reactor which is essentially vertically arranged. Such a reactor may have alternatively ascending and descending tube sections which are each other connected by means of bends having a relatively small radius. The diameter of the tube can vary. In this case, it can be advantageous for the diameter of the ascending tube sections to be at least in part smaller than the diameter of the descending sections. In the case of such reactors having a variable diameter, the above indicated length/diameter ratio is then based on the mean diameter of the tubular reactor.

The vertical arrangement of the reactor tubes achieves a particularly good contact between the gaseous monomer and growing prepolymer and also enables to avoid significantly the undesirable settling of the powder as a result of gravity. In the reactor sections with an upward flow, the gas flow velocity is generally a multiple of the minimum fluidization velocity, while in the reactor sections with a downward particle flow, the gas velocity can be significantly lower.

In the case of separation of gas and solid in the upper part of the reactor, the gas can here even move in countercurrent to the particle phase, i.e. in an upward direction in a gas circuit separate from the main flow. The reactor sections with downward particle flow can thus be operated either in a slightly fluidized state or as trickle reactors with relatively high proportions of solid phase.

A gaseous stream containing olefin monomer and prepolymer particles is discharged from the tubular reactor and is continuously fed to the successive polymerization step b), which can be carried out in one gas-phase reactor or in a sequence of two or more serially connected gas-phase reactors. Fluidized bed reactors or stirred bed reactors can be used to this purpose. In alternative, the polymerization step b) can be performed in a gas-phase reactor having interconnected polymerization zones, as described in the Applicant's earlier EP 782 587 and EP 1 012 195.

It is therefore another object of the present invention an apparatus for the gas-phase polymerization of α-olefins, the apparatus comprising a sequence of a gas-phase tubular prepolymerization reactor and one or more gas-phase polymerization reactors selected from fluidized bed reactors, stirred bed reactors and reactors having interconnected polymerization zones, said gas-phase tubular prepolymerization reactor having a length/diameter ratio higher than 100 and comprising at least a facility for feeding a reaction gas, at least a facility for feeding catalyst components and at least a facility for transferring the formed prepolymer to said one or more gas-phase polymerization reactors.

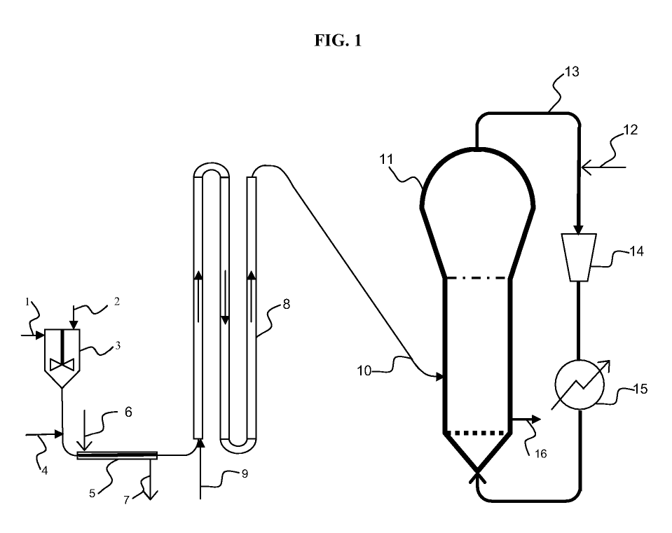

The present invention will be now described in detail with reference to FIG. 1, which is illustrative and not limitative of the scope of the present invention.

According to the embodiment shown in FIG. 1 the prepolymerization treatment of the catalyst system (step a) is carried out in a tubular reactor, while the polymerization step b) is carried out in a fluidized bed reactor.

A solid catalyst component 1, a cocatalyst 2 and optionally a donor compound, are fed to a pre-contacting vessel 3 together with a liquid diluent, such as propane. These components are contacted in the vessel 3 at a temperature ranging from 0° C. to 60° C. for a time of 5-90 minutes.

After leaving the pre-contacting vessel 3, the activated catalyst slurry is diluted by feeding additional propane via line 4 before entering a jacketed pipe 5, wherein the evaporation of propane is carried out by feeding and discharging steam from the jacket via lines 6 and 7. The gas/solid stream exiting the jacketed pipe 5 is successively introduced into a tubular reactor 8 having a length/diameter ratio >100 together with a flow of olefin monomer to carry out the gas-phase prepolymerization of the present invention. The olefin monomer, optionally together with a molecular weight regulator such as hydrogen, is fed to the tubular reactor 8 via line 9. A gas/prepolymer flow exits from the tubular reactor 8 and enters a fluidized bed reactor 11 via line 10.

One or more olefin monomers are thus polymerized in the fluidized bed reactor 11 in the presence of the prepolymerized catalyst system coming from the tubular reactor 8 and in the presence of H₂ as molecular weight regulator. To this aim, a gaseous mixture comprising the monomers, hydrogen and propane, as an inert diluent, is fed to the reactor via one or more lines 12, suitably placed at any point of the gas recycle line 13 according to the knowledge of those skilled in art. The gas recycle line 13 comprises also cooling means 14 and compression means 15, so that after to be subjected to cooling and compression, the reacting gaseous monomers are continuously recycled to the bottom of the fluidized bed reactor 11. Polymer particles are continuously discharged from the fluidized bed reactor 11 via the discharge line 16.

The gas-phase polymerization process of the invention allows the preparation of a large number of olefin powders having an optimal particle size distribution with a low content of fines. The α-olefins preferably polymerized by the process of the invention have formula CH₂═CHR, where R is hydrogen or a hydrocarbon radical having 1-12 carbon atoms. Examples of polymers that can be obtained are
high-density polyethylenes (HDPEs having relative densities higher than 0.940) including ethylene homopolymers and ethylene copolymers with α-olefins having 3 to 12 carbon atoms;
linear polyethylenes of low density (LLDPEs having relative densities lower than 0.940) and of very low density and ultra low density (VLDPEs and ULDPEs having relative densities lower than 0.920 down to 0.880) consisting of ethylene copolymers with one or more α-olefins having 3 to 12 carbon atoms;
elastomeric terpolymers of ethylene and propylene with minor proportions of diene or elastomeric copolymers of ethylene and propylene with a content of units derived from ethylene of between about 30 and 70% by weight;
isotactic polypropylene and crystalline copolymers of propylene and ethylene and/or other α-olefins having a content of units derived from propylene of more than 85% by weight;
isotactic copolymers of propylene and α-olefins, such as 1-butene, with an α-olefin content of up to 30% by weight;
impact-resistant propylene polymers obtained by sequential polymerisation of propylene and mixtures of propylene with ethylene containing up to 30% by weight of ethylene;
atactic polypropylene and amorphous copolymers of propylene and ethylene and/or other α-olefins containing more than 70% by weight of units derived from propylene;
   The gas-phase polymerization process of the invention can be carried out in the presence of a highly active catalyst system of the Ziegler-Natta or metallocene type.

A Ziegler-Natta catalyst system comprises the catalysts obtained by the reaction of a transition metal compound of groups 4 to 10 of the Periodic Table of Elements (new notation) with an organometallic compound of group 1, 2, or 13 of the Periodic Table of element.

In particular, the transition metal compound can be selected among compounds of Ti, V, Zr, Cr, and Hf. Preferred compounds are those of formula Ti(OR)ₙX_{y-n} in which n is comprised between 0 and y; y is the valence of titanium; X is halogen and R is a hydrocarbon group having 1-10 carbon atoms or a COR group. Among them, particularly preferred are titanium compounds having at least one Ti-halogen bond such as titanium tetrahalides or halogenalcoholates. Preferred specific titanium compounds are TiCl₃, TiC₄, Ti(OBu)₄, Ti(OBu)Cl₃, Ti(OBu)₂Cl₂, Ti(OBu)₃Cl.

Preferred organometallic compounds are the organo-Al compounds and in particular Al-alkyl compounds. The alkyl-Al compound is preferably chosen among the trialkyl aluminum compounds such as for example triethylaluminum, triisobutylaluminum, tri-n-butylaluminum, tri-n-hexylaluminum, tri-n-octylaluminum. It is also possible to use alkylaluminum halides, alkylaluminum hydrides or alkylaluminum sesquichlorides such as AlEt₂Cl₃ and Al₂Et₃Cl₃ optionally in mixture with said trialkyl aluminum compounds.

Particularly suitable high yield ZN catalysts are those wherein the titanium compound is supported on magnesium halide which is preferably MgCl₂.

If a stereospecific polymerization of propylene or higher alpha-olefins is aimed, internal electron donor compounds (ID) can be added in the catalyst preparation: such compounds are generally selected from esters, ethers, amines, and ketones. In particular, the use of compounds belonging to 1,3-diethers, phthalates, benzoates and succinates is preferred.

Further improvements can be obtained by using, in addition to the electron-donor present in the solid component, an external electron-donor (ED) added to the aluminium alkyl co-catalyst component or to the polymerization reactor. These external electron donors can be selected among esters, ketones, amines, amides, nitriles, alkoxysilanes and ethers. The electron donor compounds (ED) can be used alone or in mixture with each other. Preferably the ED compound is selected among aliphatic ethers, esters and alkoxysilanes. Preferred ethers are the C₂-C₂₀ aliphatic ethers and in particular the cyclic ethers preferably having 3-5 carbon atoms, such as tetrahydrofurane (THF), dioxane.

Preferred esters are the alkyl esters of C₁-C₂₀ aliphatic carboxylic acids and in particular C₁-C₈ alkyl esters of aliphatic mono carboxylic acids such as ethylacetate, methyl formiate, ethylformiate, methylacetate, propylacetate, i-propylacetate, n-butylacetate, i-butylacetate. The preferred alkoxysilanes are of formula Rₐ¹R_{b}²Si(OR³)_{c}, where a and b are integer from 0 to 2, c is an integer from 1 to 3 and the sum (a+b+c) is 4; R¹, R², and R³, are alkyl, cycloalkyl or aryl radicals with 1-18 carbon atoms. Particularly preferred are the silicon compounds in which a is 1, b is 1, c is 2, at least one of R¹ and R² is selected from branched alkyl, cycloalkyl or aryl groups with 3-10 carbon atoms and R³ is a C₁-C₁₀ alkyl group, in particular methyl. Examples of such preferred silicon compounds are methylcyclohexyldimethoxysilane, diphenyldimethoxysilane, methyl-t-butyldimethoxysilane, dicyclopentyldimethoxysilane. Moreover, are also preferred the silicon compounds in which a is 0, c is 3, R² is a branched alkyl or cycloalkyl group and R³ is methyl. Examples of such preferred silicon compounds are cyclohexyltrimethoxysilane, t-butyltrimethoxysilane and thexyltrimethoxysilane.

The above cited catalysts show, in addition to a high polymerization activity, also good morphological properties that make them particularly suitable for the use in the gas-phase polymerization process of the invention.

Also metallocene-based catalyst systems can be used in the process of the present invention and they comprise:

at least a transition metal compound containing at least one n bond;
at least an alumoxane or a compound able to form an alkylmetallocene cation; and optionally an organo-aluminum compound.

A preferred class of metal compound containing at least one n bond are metallocene compounds belonging to the following formula (I):

Cp(L)_{q}AMXₚ (I)

wherein
M is a transition metal belonging to group 4, 5 or to the lanthanide or actinide groups of the Periodic Table of the Elements; preferably M is zirconium, titanium or hafnium;
the substituents X, equal to or different from each other, are monoanionic sigma ligands selected from the group consisting of hydrogen, halogen, R⁶, OR⁶, OCOR⁶, SR⁶, NR⁶₂ and PR⁶₂, wherein R⁶ is a hydrocarbon radical containing from 1 to 40 carbon atoms;
preferably, the substituents X are selected from the group consisting of —Cl, —Br, -Me, -Et, -n-Bu, -sec-Bu, -Ph, -Bz, —CH₂SiMe₃, —OEt, —OPr, —OBu, —OBz and —NMe₂;
p is an integer equal to the oxidation state of the metal M minus 2;
n is 0 or 1; when n is 0 the bridge L is not present;
L is a divalent hydrocarbon moiety containing from 1 to 40 carbon atoms, optionally containing up to 5 silicon atoms, bridging Cp and A, preferably L is a divalent group (ZR⁷₂)ₙ;
Z being C, Si, and the R⁷ groups, equal to or different from each other, being hydrogen or a hydrocarbon radical containing from 1 to 40 carbon atoms;
more preferably L is selected from Si(CH₃)₂, SiPh₂, SiPhMe, SiMe(SiMe₃), CH₂, (CH₂)₂, (CH₂)₃ or C(CH₃)₂;
Cp is a substituted or unsubstituted cyclopentadienyl group, optionally condensed to one or more substituted or unsubstituted, saturated, unsaturated or aromatic rings;
A has the same meaning of Cp or it is a NR⁷, —O, S, moiety wherein R⁷ is a hydrocarbon radical containing from 1 to 40 carbon atoms;
Alumoxanes used as component b) are considered to be linear, branched or cyclic compounds containing at least one group of the type:

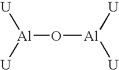

wherein the substituents U, same or different, are defined above.

In particular, alumoxanes of the formula:

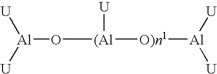

can be used in the case of linear compounds, wherein n¹ is 0 or an integer of from 1 to 40 and where the U substituents, same or different, are hydrogen atoms, halogen atoms, C₁-C₂₀-alkyl, C₃-C₂₀-cyclalkyl, C₆-C₂₀-aryl, C₇-C₂₀-alkylaryl or C₇-C₂₀-arylalkyl radicals, optionally containing silicon or germanium atoms, with the proviso that at least one U is different from halogen, and j ranges from 0 to 1, being also a non-integer number; or alumoxanes of the formula:

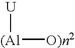

can be used in the case of cyclic compounds, wherein n² is an integer from 2 to 40 and the U substituents are defined as above.

The following examples will further illustrate the present invention without limiting its scope.

### EXAMPLES

### Characterization

| | |
|---|---|
| Melt index E (MIE): | ASTM-D 1238 (190° C./2.16 Kg) |
| Melt index N (MIN): | ASTM-D 1238 (190° C./10.0 Kg) |
| Density (not annealed): | ASTM-D 792 |

### Particle Size Distribution (PSD):

The particle size distribution of the polymeric material was determined by sieving a product sample. Over a period of 6 hours, in which reactor conditions were maintained stable, 3 product samples are taken. The final PSD of the run is the average of the three PSD's measured on the three samples.

### General Polymerization Conditions

The polymerization process of the invention was carried out in continuous in a process setup as shown in FIG. 1 comprising:
a pre-contacting vessel, where the various catalyst components were premixed;
a prepolymerization tubular reactor having a length/diameter ratio of 800;
a fludized bed reactor.

### Example 1 (Comparative)

A Ziegler-Natta catalyst was used as the polymerization catalyst, comprising:
a titanium solid catalyst component prepared with the procedure described in WO 04/106388, Example 1, according to which ethylacetate is used as an internal donor compound;
triisobutylaluminum (TIBAL) as a cocatalyst;
tetrahydrofuran as an external donor.

About 10 g/h of solid catalyst component were fed to the catalyst activation vessel, together with the cocatalyst and the external donor, the weight ratio TIBAL/solid component being of 10, the weight ratio TIBAL/external donor being of 15.

The above catalyst components were pre-contacted in propane at a temperature of 50° C. for 30 minutes. Conditions of the activation step are summarized in Table 1.

After leaving the activation vessel, the activated catalyst was fed to the fluidized bed reactor without carrying out any prepolymerization step. In this gas-phase reactor ethylene was polymerized using H₂ as the molecular weight regulator and in the presence of propane as inert diluent.

The polymerization was carried out at a temperature of 80° C. and at a pressure of 24 barg.

The complete gas composition of the fluidizing gas is given in Table 3.

The polymer material produced at these conditions had a melt flow rate at conditions “E” of 51 g/10′ and a polymer density of 0.9678 g/mL. The detailed properties of the polymer material are given in Table 4.

In a period of 6 hours, three polymer samples were taken from the fluidized bed reactor, to determine the particle size distribution (PSD) of the polymer material. The three PSD's were averaged and the results are given in Table 4.

### Example 2 (Comparative)

### Liquid Phase Prepolymerization in a Tube Reactor

A Ziegler-Natta catalyst as described in Example 1 was used as the polymerization catalyst. About 10 g/h of solid catalyst component were fed to the catalyst activation vessel, together with the cocatalyst and the external donor, the weight ratio TIBAL/solid component being of 10, the weight ratio TIBAL/external donor being of 15. The above catalyst components were pre-contacted in propane at a temperature of 50° C. for 30 minutes. The pre-activation conditions are summarized in Table 1.

According to this example, no vapor was fed to the jacket pipe 5 of FIG. 1, so that the pre-activated catalyst system was fed to the tubular reactor 8 as a slurry stream. Ethylene was fed to the tubular reactor 8 via line 9 to carry out the prepolymerization of the catalyst system. The temperature of the tubular reactor was kept at 50° C.

The weight ratio ethylene/(solid catalyst) fed to the tube reactor was equal to 25. The prepolymerization conditions are summarized in Table 2.

After leaving the prepolymerization reactor, the prepolymer was fed to the fluidized bed reactor. In this reactor, ethylene was polymerized using H₂ as the molecular weight regulator and in the presence of propane as inert diluent. The polymerization was carried out at a temperature of 80° C. and at a pressure of 24 barg. The complete gas composition of the fluidizing gas is given in Table 3.

After relatively short run duration (<20 hours), plugging of line 10 in FIG. 1 connecting the tube reactor 8 with the fluidized bed reactor 11 was observed. In spite of the cleaning of line 10, it kept plugging a large number of times in a short period. After shutting down the plant, inspection of the prepolymerization tubular reactor showed significant polymer deposits at the inner reactor wall.

The polymer material produced during the relatively short runs at these conditions had a melt flow rate at conditions “E” of 46 g/10′, and a polymer density of 0.9667 g/mL. The properties of the polymer material are given in Table 4.

Due to the unstable nature of the polymerization runs, it was not possible to take representative polymer samples from the polymerization reactor to determine the particle size distribution.

### Example 3

### Gas Phase Prepolymerization in a Tube Reactor

A Ziegler-Natta catalyst as described in Example 1 was used as the polymerization catalyst. About 10 g/h of solid catalyst component were fed to the catalyst activation vessel, together with the cocatalyst and the external donor, the weight ratio TIBAL/solid component being of 10, the weight ratio TIBAL/external donor being of 15. The above catalyst components were pre-contacted in propane at a temperature of 50° C. for 30 minutes.

After leaving the activation vessel, the catalyst slurry was diluted with propane and heated by means of the jacketed pipe 5 of FIG. 1.

According to this example, vapor was fed to the jacketed pipe 5 to cause the propane vaporization, so that the pre-activated catalyst system was fed to the tubular reactor 8 as a gas/solid stream. Ethylene was fed to the tubular reactor 8 via line 9 to carry out the prepolymerization of the catalyst system.

The amount of ethylene fed to the tubular reactor was such to satisfy the selected ethylene concentration in the reactor of 2% by mol. The tube reactor was operated at 80° C. and 24 barg. The conditions of the prepolymerization are summarized in Table 2.

After leaving the prepolymerization reactor, the prepolymer was fed to the fluidized bed reactor 11. In this reactor ethylene was polymerized using H₂ as the molecular weight regulator and in the presence of propane as inert diluent. The polymerization was carried out at a temperature of 80° C. and at a pressure of 24 barg. The gas composition of the fluidizing gas is given in Table 3.

The polymer material produced at these conditions had a melt flow rate at conditions “E” of 48 g/10′, and a polymer density of 0.9671 g/mL. The properties of the polymer material are given in Table 4.

In a period of 6 hours, three polymer samples were taken from the fluidized bed reactor to determine the particle size distribution (PSD) and the poured bulk density of the polymer material. The three PSD's were averaged and the results are given in Table 4. This table shows that the poured bulk density of the material has significantly increased compared to the polymer of Example 1. At the same time, the concentration of fine particles has significantly decreased.

### Example 4

### Gas Phase Prepolymerization in a Tube Reactor

The same operative conditions of Example 3 were performed with the difference that a higher ethylene concentration (5% mol instead of 2% mol) and a higher temperature (90° C. instead of 80° C.) were adopted in the tubular reactor 8 of FIG. 1.

The preactivation and pre-polymerization conditions are given in Tables 1 and 2, while the polymerization conditions are given in Table 3.

The particle size distribution of the product (Table 4) shows a morphology very similar to the one produced in Example 3. An increased poured bulk density and a low level of fines are achieved also at a higher ethylene content in the tube reactor.

TABLE 1
Operating conditions in catalyst activation

| | Example 1 | Example 2 | | |
|---|---|---|---|---|
| | (Comp) | (Comp) | Ex. 3 | Ex. 4 |
| TIBAL/catalyst (wt ratio) | 10 | 10 | 10 | 10 |
| TIBAL/THF (wt ratio) | 15 | 15 | 15 | 15 |
| Temperature (° C.) | 50 | 50 | 50 | 50 |
| Residence time (Min) | 30 | 30 | 30 | 30 |

TABLE 2
Operating conditions in prepolymerization

| | Example 1 | Example 2 | | |
|---|---|---|---|---|
| | (Comp.) | (Comp.) | Example 3 | Example 4 |
| Temperature (° C.) | — | 50 | 80 | 90 |
| Pressure (Barg) | — | 24 | 24 | 24 |
| (*) Residence time (sec) | — | 1650 | 59 | 54 |
| C₂H₄/catalyst (wt ratio) | — | 15 | — | — |
| C₂H₄ in gas phase | — | — | 2 | 5 |
| (% mol) | | | | |
| Polymerization degree | — | — | 1.6 | 3.8 |
| (g. prepolymer/g. | | | | |
| catalyst) | | | | |

(*) Residence time of catalyst/prepolymer was calculated on basis of solid properties and the fluidynamics of the tube reactor

TABLE 3
Operating conditions in the fluidized bed reactor

| | Example 1 | Example 2 | | |
|---|---|---|---|---|
| | (Comp.) | (Comp.) | Example 3 | Example 4 |
| Pressure (barg) | 24 | 24 | 24 | 24 |
| Temperature (° C.) | 80 | 80 | 80 | 80 |
| C₂H₄ (% mol) | 11.8 | 12.1 | 12.3 | 12.0 |
| H₂ (% mol) | 20.3 | 20.3 | 20.4 | 20.5 |
| C₃H₈ (% mol) | 67.9 | 67.6 | 67.3 | 67.5 |
| H₂/C₂H₄ (mol ratio) | 1.72 | 1.68 | 1.66 | 1.71 |

TABLE 4
Product properties

| | | | |
|---|---|---|---|
| Ex. 1 | Ex. 2 | | |
| (Comp.) | (Comp.) | Ex. 3 | Ex. 4 |

Polymer characteristics

| | | | | | |
|---|---|---|---|---|---|
| Melt flow rate “E” | g/10 min | 51 | 46 | 48 | 49 |
| Melt flow rate “N” | g/10 min | 398 | 336 | 371 | 366 |
| Melt flow ratio “N/E” | — | 7.8 | 7.3 | 7.7 | 7.5 |
| Density (non annealed) | g/L | 0.9678 | 0.9667 | 0.9671 | 0.9668 |

Powder morphology

| | | | | | |
|---|---|---|---|---|---|
| Poured bulk density | g/L | 0.331 | 0.322 | 0.376 | 0.374 |
| Average particle size | micron | 856 | n.m. | 1322 | 1318 |
| Fraction < 106 μm | wt % | 4.6 | n.m. | 0.3 | 0.1 |
| Fraction < 125 μm | wt % | 5.9 | n.m. | 0.6 | 0.2 |
| Fraction < 180 μm | wt % | 9.0 | n.m. | 1.0 | 0.6 |
| Fraction < 300 μm | wt % | 14.2 | n.m. | 1.4 | 1.5 |
| Fraction < 500 μm | wt % | 23.1 | n.m. | 3.6 | 4.3 |
| Fraction < 710 μm | wt % | 38.5 | n.m. | 9.4 | 10.9 |
| Fraction < 1000 μm | wt % | 61.4 | n.m. | 27.2 | 28.4 |
| Fraction > 1000 μm | wt % | 38.6 | n.m. | 72.8 | 71.6 |

n.m. = not measurable

1. A process for the gas-phase polymerization of one or more alpha-olefins in the presence of a polymerization catalyst system, the process comprising:
a) contacting in a continuous way a gas comprising one or more of said alpha-olefins with said catalyst system in a gas-phase tubular reactor at a temperature from 30° C. to 130° C. in order to obtain a polymerization degree up to 500 grams per gram of catalyst system;
b) feeding in continuous the prepolymer from step a) to a successive gas-phase polymerization reactor;
wherein said gas-phase tubular reactor has a length/diameter ratio higher than 100.

2. The process according to claim 1, wherein said length/diameter ratio is from 100 to 2000.

3. The process according to any of claim 1, wherein the polymer residence time in step a) ranges from 10 seconds to 15 minutes.

4. The process according to claim 1, wherein said gas of step a) comprises an inert compound selected from nitrogen, ethane, propane, butane, pentane and hexane.

5. The process according to claim 1, wherein the gas velocity in step a) is maintained in a range from 15 to 300 cm/s.

6. The process according to claim 1, wherein the temperature in step a) ranges from 70 to 120° C.

7. The process according to claim 1, wherein the pressure in step a) is from 1 to 100 bar.

8. The process according to claim 1, wherein said polymerization degree in step a) ranges from 0.1 to 100 grams per gram of solid catalyst component.

9. The process according to claim 1, wherein said polymerization catalyst system is selected from a Ziegler-Natta and/or a metallocene-based catalyst system.

10. The process according to claim 1, wherein upstream step a) the pre-contact of the catalyst components in a liquid medium and the successive evaporation of said liquid medium are performed.

11. The process according to claim 1, wherein said tubular reactor comprises at least a facility for feeding the reaction gas, at least a facility for feeding the catalyst components, at least a facility for transferring the formed prepolymer to one or more polymerization reactors, and optionally a facility for separating the reaction gas from the prepolymer particles and recirculating said reaction gas to the inlet region of said tubular reactor.

12. The process according to claim 11, wherein said tubular reactor is arranged essentially vertically, with alternatively ascending and descending tube sections which are each other connected by means of bends.

13. The process according to claim 1, wherein said gas-phase polymerization reactor of step b) is selected from fluidized bed reactors, stirred bed reactors and gas-phase reactors having interconnected polymerization zones.

14. An apparatus for the gas-phase polymerization of α-olefins comprising a sequence of a gas-phase tubular prepolymerization reactor and one or more gas-phase polymerization reactors, said tubular prepolymerization reactor having a length/diameter ratio higher than 100 and comprising at least a facility for feeding a reaction gas, at least a facility for feeding catalyst components, at least a facility for transferring the formed prepolymer to said one or more gas-phase polymerization reactors, and optionally a facility for separating the reaction gas from the prepolymer particles and recirculating said reaction gas to the inlet region of said tubular reactor.

15. The apparatus according to claim 14, wherein said one or more gas-phase polymerization reactors are selected from fluidized bed reactors, stirred bed reactors and gas-phase reactors having interconnected polymerization zones.
